(19) United States
(12) Patent Application Publication
(10) Pub. No.: US 2023/0388398 A1
(43) Pub. Date: Nov. 30, 2023

(54) ENCODING OF AN IMPLICIT PACKET SEQUENCE NUMBER IN A PACKET

(71) Applicant: Intel Corporation, Santa Clara, CA (US)

(72) Inventors: Philip GLYNN, Ennis (IE); Jonathan KENNY, Ballina (IE); Andrew CUNNINGHAM, Ennis (IE); Emer ROCHE, Ennis (IE); Micheal HORAN, Killarney (IE)

(21) Appl. No.: 18/231,726

(22) Filed: Aug. 8, 2023

(51) Int. Cl. H04L 69/22; H04L 9/40; H04L 47/34

(52) U.S. Cl. CPC H04L 69/22; H04L 63/0428; H04L 47/34

(57) ABSTRACT

Examples described herein relate to a network interface device. In some examples, the network interface device includes direct memory access (DMA) circuitry, a network interface, a host interface, and circuitry. The circuitry can be configured to process a packet received by the network interface; for a first configuration, determine an Extended Sequence Number (ESN) value based on content of the packet without performance of ESN prediction; and for a second configuration, determine ESN using prediction.

### BACKGROUND

Internet Protocol Security (IPSec) is described in at least Internet Engineering Task Force (IETF) Request For Comment (RFC) 2411, “IP Security Document Roadmap,” (November 1998); RFC 2401, “Security Architecture for the Internet Protocol,” (November 1998); RFC 2402, “IP Authentication Header,” November 1998; RFC 2406, “IP Encapsulating Security Payload (ESP),” (November 1998); RFC 2408, “Internet Security Association and Key Management Protocol (ISAKMP),” (November 1998); RFC 2407, “The Internet IP Security Domain of Interpretation for ISAKMP,” (November 1998); RFC 2409, “The Internet Key Exchange (IKE),” (November 1998); RFC 3554, “On the Use of Stream Control Transmission Protocol (SCTP) with IPsec,” (July 2003); RFC 4303, “IP Encapsulating Security Payload (ESP),” (December 2005); RFC 3948, “UDP Encapsulation of IPsec ESP Packets,” (January 2005); and RFC 2411, “IP Security (IPsec) and Internet Key Exchange (IKE) Document Roadmap,” (February 2011).

Packet sequence numbers can be used for ordering data to properly decrypt ordered data, authentication processing, and for anti-replay detection. Anti-replay can attempt to thwart a replay attack, whereby data transmission is recorded and later repeated to impersonate a valid sender and disrupt a connection. IPSec utilizes anti-replay based on monitoring received sequence numbers within a window of a range of sequence numbers. Appendices A2.1 and A2.2 of RFC 4043 specify a manner of managing and using an anti-replay window. If a received packet sequence number is within the window but has been previously received, the received packet is dropped. If the received packet sequence number is within the window and has not previously been received, an integrity check is performed on the received packet. If the received packet sequence number is less than a lower bound sequence number of the window, the received packet is dropped and recorded with a replay counter. If the received packet sequence number is within or greater than the highest sequence number in the window, the received packet proceeds to integrity check. If the packet passes the integrity check, the anti-replay window is updated.

### BRIEF DESCRIPTION OF THE DRAWINGS

FIG. 1 depicts an example of packet contents.

FIG. 2 depicts an example of substructure of payload data.

FIG. 3A depict an example system.

FIG. 3B depicts an example anti-replay window.

FIGS. 4A and 4B depict example processes.

FIGS. 5A and 5B depict example network interface devices.

FIG. 6 depicts an example system.

### DETAILED DESCRIPTION

IPSec allows for use of an Extended Sequence Number (ESN), which increases the size of the sequence numbers, compared to a sequence number, and allows more packets to be transferred or in-flight for a given Internet Protocol (IP) connection. If packet sequence numbers (PSN) saturate, then a connection is to be terminated and a new connection started. ESN allows use of more PSN values and can delay saturation (e.g., reaching highest PSN value). RFC 4303 section 3.3.3 and Appendix A2.2 describe manners of sequence number generation and states: if Extended Sequence Number (ESN) is selected, only the low-order 32 bits of the sequence number are transmitted in the Sequence Number field (Seql) within the packet, although both sender and receiver maintain full 64-bit ESN counters. Accordingly, to determine the high-order 32 bits (Segh) of the ESN, the receiver predicts the implicit Seqh value and tracks the sequence number subspace into which a packet falls by the predicted value of Segh. RFC 4303 Appendix A2.2 describes various manners of determining Seqh. Prediction of high-order 32 bits (or other number of bits) utilizes a top of window (TOW) value and anti-replay window size. A TOW value can indicate an upper sequence number of the anti-replay window. An example TOW value is described at least in RFC 4303 at Appendix A2.1 as variable T, which can represent a highest sequence number authenticated or upper bound of the window.

The TOW value in the anti-replay window can be updated with a packet sequence number, associated with an authenticated packet, that is greater than a current TOW value. In some designs, a packet can be authenticated and the SN accepted before the Top of Window (TOW) is updated. Accordingly, ESN prediction can occur with an out-of-date TOW, and if gaps in SNs exceed a level, synchronization can be lost, which can lead to packet loss or drops. Synchronization loss can be due to gaps in sequence numbers exceeding a particular level. Synchronization loss can lead to ESN prediction incorrectly predicting ESNs, leading to authentication failures, packet drops, and retransmission of packets. Synchronization loss can lead to a connection being terminated.

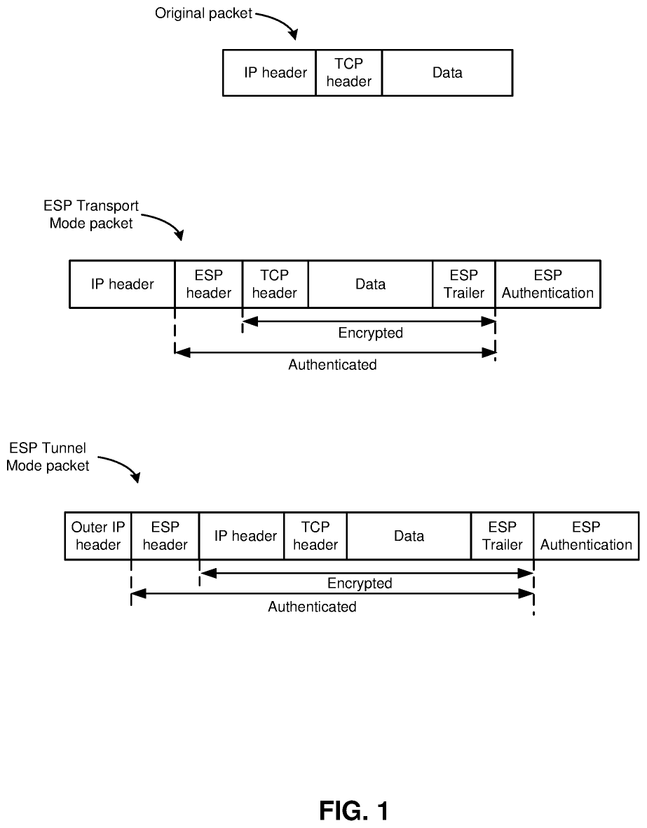

FIG. 1 depicts an example of packet contents. This example shows a packet (Original packet) and a version of the Original packet encrypted according to an IPSec packet format that is consistent with Encapsulating Security Payload (ESP) based on RFC 4303. However, Original packet can be encrypted according to other IPSec packet formats such as Authentication Header (AH) based on RFC 2402. Moreover, Original packet can be encrypted based on ESP and AH.

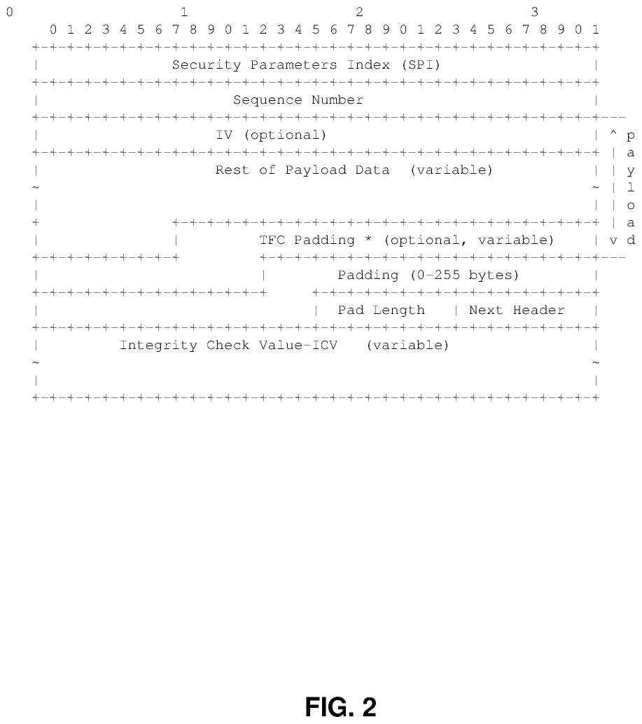

FIG. 2 depicts an example of substructure of a packet. The example substructure is based on RFC 4303. In some examples, a packet sequence number (PSN) is transmitted in the packet header. As shown, an Initialization Vector (IV) value can be included in a packet payload. Authenticated encryption with associated data (AEAD) Authentication (e.g., Advanced Encryption Standard with Galois/Counter Mode (AES-GCM) and ChaChaPoly (CCP)) can utilize IV from the payload. For example, use of IVs for encryption and decryption are described at least in RFC 4106, “The Use of Galois/Counter Mode (GCM) in IPsec Encapsulating Security Payload (ESP)” (June 2005); RFC 4543 “The Use of Galois Message Authentication Code (GMAC) in IPsec ESP and AH” (May 2006); and RFC 7634, “ChaCha20, Poly1305, and Their Use in the Internet Key Exchange Protocol (IKE) and IPsec” (August 2015).

As described herein, a sender can store the upper bits of the ESN (Segh) in the IV field of a packet. On the receiver side, the ESN can be extracted from the IV and used in packet processing, allowing the IV to remain unique. Transmitting the ESN in the IV field increases IPsec reliability by preventing synchronization loss without the need for a dedicated field in the IPsec header. Moreover, a receiver need not perform ESN prediction as the ESN can be defined explicitly. The receiver can concatenate the Seqh with the Seql from the received sequence number. However, ESN prediction can be utilized if the IV field includes the Seqh, the IV field does not include Seqh, or the IV field includes a strict subset of the Seqh (e.g., less than all bits of the Segh).

The value in the IV, when used in IPsec with AEAD, is to be unique per packet, but there is no requirement for the IV to be unpredictable. IV can be predictable and include counter value such as the ESN. In some examples, the ESN and the SN can be concatenated and sent in the IV of the payload. This removes the need for ESN prediction, thereby increasing reliability on the network and reducing design complexity. Providing bits of the ESN in the IV can provide for encoding of implicit packet sequence number.

In some examples, if a protocol has reserved field in a header, the reserved field can include a portion of the upper bits of the ESN (Segh).

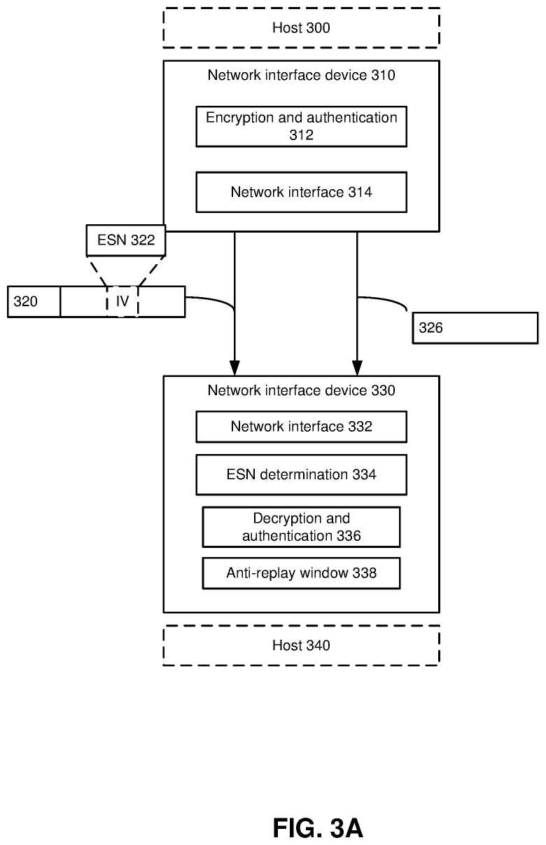

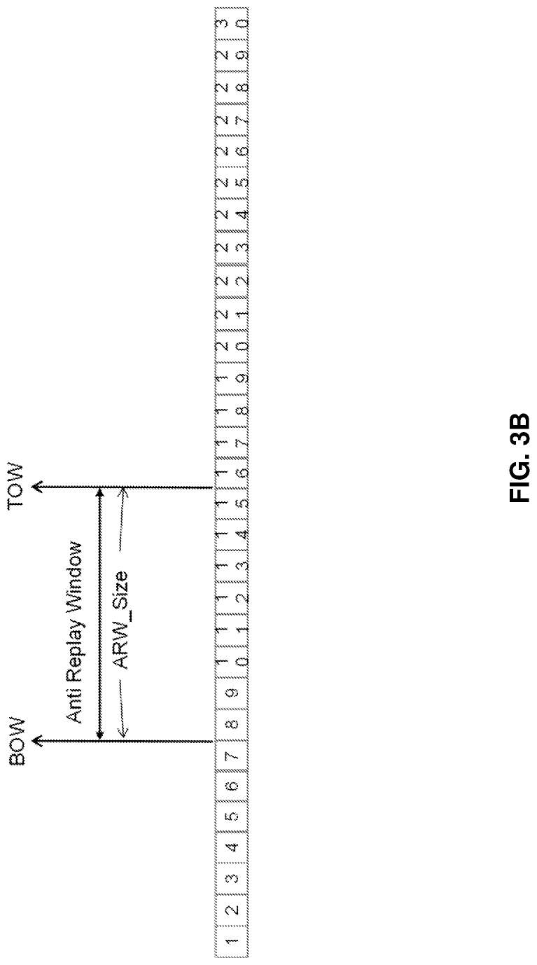

FIG. 3A depict an example system. In some examples, network interface device 310 can transmit packets with data from host 300. In some examples, network interface device 310 can forward packets received from another network interface device (not shown) to network interface device 330. Network interface device 310 can utilize encryption and authentication 312 to encrypt an entirety or subset of header and/or entirety or subset of payload of packet 320 based on IPsec, IEEE 802.1AE-2008 (MACsec), Transport Layer Security (TLS) (e.g., The Transport Layer Security (TLS) Protocol Version 1.3, RFC 8446 (August 2018)), Datagram Transport Layer Security (DTLS) (e.g., Network Working Group Request for Comments (RFC) 4347 (2006) and Internet Engineering Task Force (IETF) Datagram Transport Layer Security (DTLS) protocol Version 1.3 (2020)), Google® PSP Security Protocol (PSP), or others.

Sequence numbers and extended sequence numbers are to increment for sequentially transmitted packets. In some examples, in a first mode or configuration, encryption and authentication 312 can provide extended sequence numbers in packets 320. In some examples, extended sequence numbers (ESN) 322 can be positioned in IV of a payload of a packet 320. For example, ESN 322 can include high-order bits of an ESN (e.g., bits 32-63) whereas low-order bits of the ESN can be in the Sequence Number field (e.g., bits 0-31). Examples can apply provide bits of an ESN for protocols other than IPSec, such as MACsec, TLS, DTLS, PSP, or others.

In some examples, in a second mode or configuration, encryption and authentication 312 can provide one or more bits of an ESN in header and/or payload of packet 326.

In some examples, in a third mode or configuration, encryption and authentication 312 can provide one or more bits of the Seqh of the ESN in header and/or payload of packet 326 and a receiver can perform prediction of remaining bits of the Seqh.

Network interface device 310 can transmit packets 320 and/or 326 via network interface 314 to network interface device 330. Network interface 314 may be configured to use any one or more communication technology (e.g., wired or wireless communications) and associated protocols (e.g., Ethernet, Bluetooth®, Wi-Fi®, 4G LTE, 5G, etc.) to perform such communication. Network interface 314 can include one or more network hardware resources, such as ingress queues, egress queues, direct memory access (DMA) circuitry, crossbars, shared memory switches, media access control (MAC), physical layer interface (PHY), Ethernet port logic, and other network hardware resources.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Network interface device 330 can utilize network interface 332 to receive packets. Network interface 332 can be implemented in a similar manner as network interface 314. In a first mode or configuration, ESN determination 334 can determine an ESN of packet 320 based on ESN 322 in IV of packet 320. In a second or third mode or configuration, ESN determination 334 can determine an ESN of packet 326 based on prediction of ESN in accordance at least with RFC 4303 section 3.3.3 and Appendix A2.2.

Network interface device 330 can utilize decryption and authentication 336 to decrypt packet 320 or 326 based on an application encryption protocol. Packet authentication can be performed based at least on Network Working Group RFC 4302, “IP Authentication Header” (December 2005). For example, portions of the packet header (e.g., IP header) can be used to authenticate a sender or origin of the packet. If packet authentication fails, an intermediate buffer with packet data can be cleared or marked as invalid and an interrupt can be raised and a system level action takes place (e.g., stop a collective operation, restart a collective operation, identify a potentially compromised network interface device).

For a packet flow, anti-replay window 338 can track receipt of sequence numbers and adjust a window start and end based on ESN values in accordance with IPSec standards. In some examples, network interface device 330 can encrypt packet content in a similar manner as encryption and authentication 312 and forward the encrypted packets to another network interface device (not shown). In some examples, network interface device 330 can provide decrypted packet header and/or payload data to host 340.

In some examples, network interface device 310 and/or 330 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, components of network interface device 310 and/or 330 can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others.

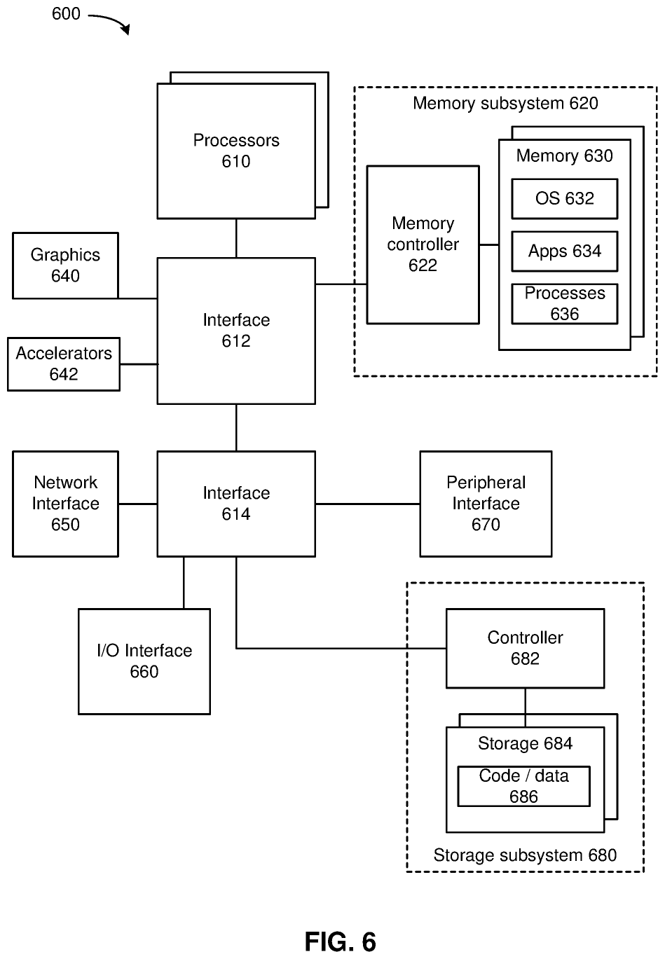

Host 300 and host 340 can include one or more processor other circuitry and/or software described at least with respect to the system of FIG. 6.

FIG. 3B depicts an example anti-replay window. A size of the anti-replay window (ARW_Size) can be 8 PSNs and can start at a bottom of window (BOW) sequence number and ends at top of window (TOW) sequence number. The ant-replay BOW and TOW can be adjusted as described at least in Appendices A2.1 and A2.2 of RFC 4043.

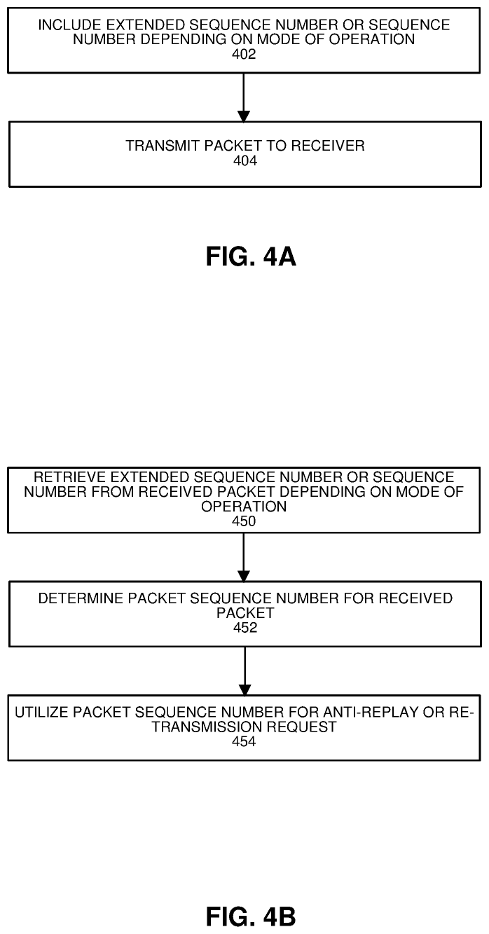

FIG. 4A depicts an example process. The process can be performed by circuitry, processor-executed software, and/or firmware of a network interface device. In some examples, the process can be performed by network interface device 310 of FIG. 3A. At 402, based on formation of a packet for transmission, the network interface device can cause a packet sequence number value or extended packet sequence number value to be written to a packet payload and/or header. For example, in a first mode or configuration, one or more bits of the extended sequence number can be positioned in an IV (or other portion) of a payload of the packet if the packet is encrypted using IPsec. For example, the extended sequence number can include high-order bits and low-order bits. For example, in a second mode or configuration, one or more bits of an extended sequence number can be provided in the packet header. Packet sequence numbers increment by one for consecutively transmitted packets. At 404, the packet can be transmitted to a receiver network interface device.

FIG. 4B depicts an example process. The process can be performed by circuitry, processor-executed software, and/or firmware of a network interface device. In some examples, the process can be performed by network interface device 330 of FIG. 3A. At 450, based on receipt of a packet, the network interface device can access a packet sequence number value or extended packet sequence number value based on a mode or configuration of operation of the network interface device. The packet sequence number value or extended packet sequence number value can be retrieved from a header and/or payload of the packet. In some examples, one or more bits of the extended sequence number can be positioned in an IV (or other portion) of a payload of the packet if the packet is encrypted using IPsec. At 452, the network interface device can determine a packet sequence number or extended packet sequence number value for the received packet. In some examples, in a configuration or mode where one or more bits of the extended packet sequence number value is provided in the header and/or payload of the packet, the network interface device can determine the extended packet sequence number value from the provided one or more bits of the extended packet sequence number value. In some examples, in a configuration or mode where an extended packet sequence number value is not provided, prediction of the extended packet sequence number can be performed. At 454, the packet sequence number can be used to thwart anti-replay attacks or determine whether to request a sender network interface device to re-transmit packets associated with packet sequence numbers that were not received. For example, after non-receipt of a packet sequence number following expiration of a timer, a request to re-transmit the packet with the non-received packet sequence number can be transmitted to a sender network interface device.

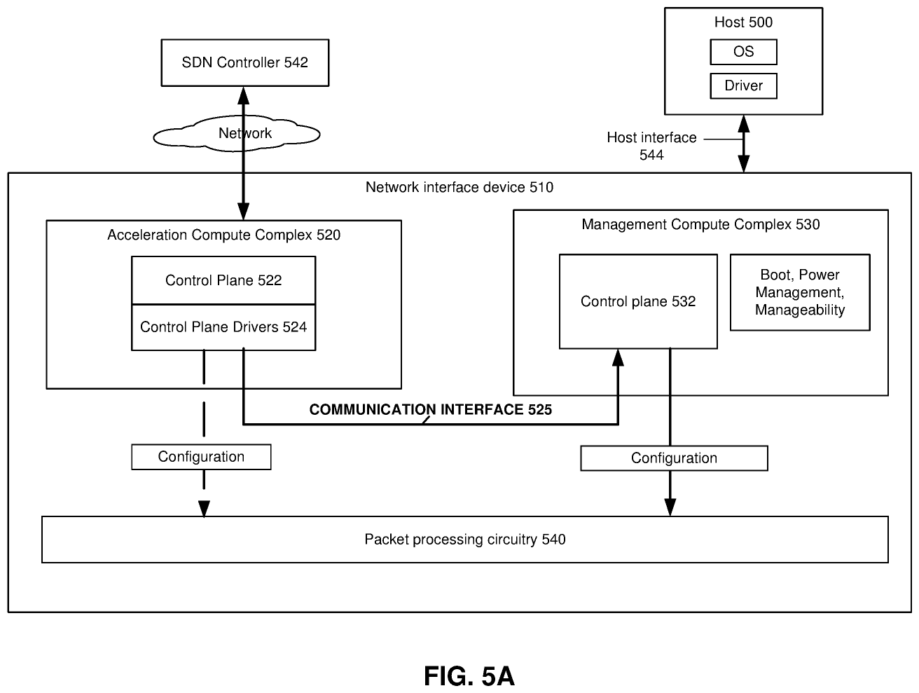

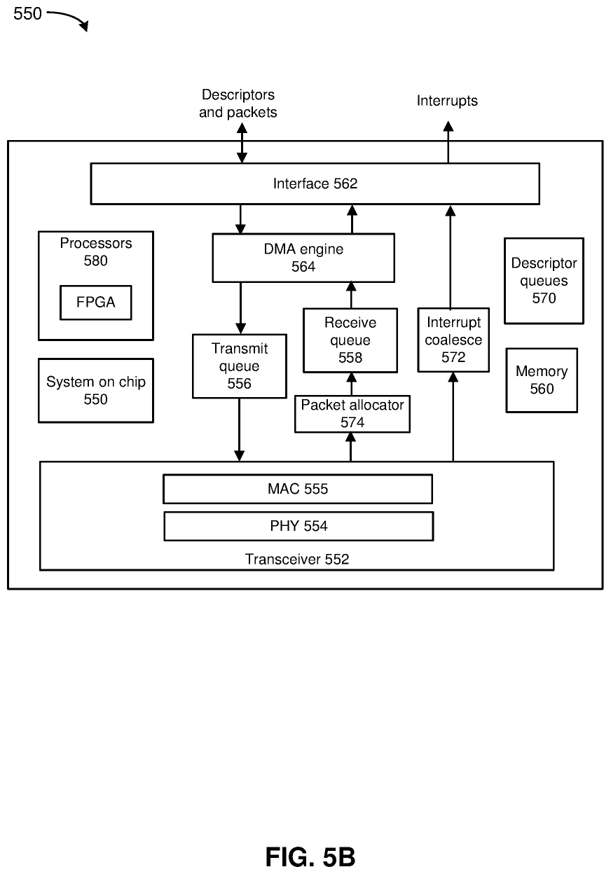

FIG. 5A depicts an example system. Host 500 can include processors, memory devices, device interfaces, as well as other circuitry such as described with respect to one or more of FIGS. 5B, and/or 6. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to FIGS. 5B, and/or 6. Similarly, MCC 530 can be implemented as one or more of: a microprocessor, processor, accelerator, field programmable gate array (FPGA), application specific integrated circuit (ASIC) or circuitry described at least with respect to FIGS. 5B, and/or 6. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described at least with respect to FIGS. 5B, and/or 6. Packet processing pipeline circuitry 540 can process packets as directed or configured by one or more control planes executed by multiple compute complexes. In some examples, ACC 520 and MCC 530 can execute respective control planes 522 and 532.

Packet processing device 510, ACC 520, and/or MCC 530 can be configured to include one or more bits of the extended packet sequence number value in the header and/or payload in a packet prior to packet transmission or determine the extended packet sequence number value of a received packet based on one or more bits of the extended packet sequence number value in the received packet, as described herein.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device or packet processing device. In some examples, circuitry of network interface device can be utilized by network interface 510 (FIG. 5A) or another network interface for packet transmissions and packet receipts, as described herein. In some examples, network interface device 550 can be implemented as a network interface controller, network interface card, a host fabric interface (HFI), or host bus adapter (HBA), and such examples can be interchangeable. Packet processing device 550 can be coupled to one or more servers using a bus, PCIe, CXL, or Double Data Rate (DDR). Packet processing device 550 may be embodied as part of a system-on-a-chip (SoC) that includes one or more processors, or included on a multichip package that also contains one or more processors.

Some examples of network interface device 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 550 can include transceiver 552, transmit queue 556, receive queue 558, memory 560, host interface 562, DMA engine 564, and processors 580. Transceiver 552 can be capable of receiving and transmitting packets in conformance with the applicable protocols such as Ethernet as described in IEEE 802.3, although other protocols may be used. Transceiver 552 can receive and transmit packets from and to a network via a network medium (not depicted). Transceiver 552 can include PHY circuitry 554 and media access control (MAC) circuitry 555. PHY circuitry 554 can include encoding and decoding circuitry (not shown) to encode and decode data packets according to applicable physical layer specifications or standards. MAC circuitry 555 can be configured to assemble data to be transmitted into packets, that include destination and source addresses along with network control information and error detection hash values.

Processors 580 can be any a combination of a: processor, core, graphics processing unit (GPU), field programmable gate array (FPGA), application specific integrated circuit (ASIC), or other programmable hardware device that allow programming of network interface 550. For example, a “smart network interface” can provide packet processing capabilities in the network interface using processors 580.

Processors 580 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 580, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

As described herein, processors 580 or other circuitry can be configured to include one or more bits of the extended packet sequence number value in the header and/or payload in a packet prior to packet transmission or determine the extended packet sequence number value of a received packet based on one or more bits of the extended packet sequence number value in the received packet.

Packet allocator 574 can provide distribution of received packets for processing by multiple CPUs or cores using timeslot allocation described herein or RSS. When packet allocator 574 uses RSS, packet allocator 574 can calculate a hash or make another determination based on contents of a received packet to determine which CPU or core is to process a packet.

Interrupt coalesce 572 can perform interrupt moderation whereby network interface interrupt coalesce 572 waits for multiple packets to arrive, or for a time-out to expire, before generating an interrupt to host system to process received packet(s). Receive Segment Coalescing (RSC) can be performed by network interface 550 whereby portions of incoming packets are combined into segments of a packet. Network interface 550 provides this coalesced packet to an application.

Direct memory access (DMA) engine 564 can copy a packet header, packet payload, and/or descriptor directly from host memory to the network interface or vice versa, instead of copying the packet to an intermediate buffer at the host and then using another copy operation from the intermediate buffer to the destination buffer.

Memory 560 can be any type of volatile or non-volatile memory device and can store any queue or instructions used to program network interface 550. Transmit queue 556 can include data or references to data for transmission by network interface. Receive queue 558 can include data or references to data that was received by network interface from a network. Descriptor queues 570 can include descriptors that reference data or packets in transmit queue 556 or receive queue 558. Host interface 562 can provide an interface with host device (not depicted). For example, host interface 562 can be compatible with PCI, PCI Express, PCI-x, Serial ATA, and/or USB compatible interface (although other interconnection standards may be used).

FIG. 6 depicts a system. In some examples, circuitry of network interface device can be configured to include one or more bits of the extended packet sequence number value in the header and/or payload in a packet prior to packet transmission or determine the extended packet sequence number value of a received packet based on one or more bits of the extended packet sequence number value in the received packet, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 to generate and include one or more bits of an extended sequence number in a packet payload and/or header.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIGS. 5A and/or 5B.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. A non-volatile memory (NVM) device is a memory whose state is determinate even if power is interrupted to the device.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device comprising: direct memory access (DMA) circuitry, a network interface, a host interface, and circuitry to: process a packet received by the network interface, for a first configuration, determine an Extended Sequence Number (ESN) value based on content of the packet without performance of ESN prediction, and for a second configuration, determine ESN using prediction.

Example 2 includes one or more examples, wherein an Initialization Vector (IV) of a payload of the received packet comprises the ESN.

Example 3 includes one or more examples, wherein the IV is consistent with one or more of Internet Engineering Task Force (IETF) Request For Comment (RFC) 4106, RFC 4543, or RFC 7634.

Example 4 includes one or more examples, wherein a header of the received packet comprises the ESN.

Example 5 includes one or more examples, wherein the prediction is consistent with Internet Engineering Task Force (IETF) Request For Comment (RFC) 4303, “IP Encapsulating Security Payload (ESP),” (December 2005).

Example 6 includes one or more examples, wherein when the packet to be received is encrypted using Internet Protocol Security (IPSec), the circuitry is to not predict the ESN based on an IPSec standard or when the packet to be received is encrypted using IPSec, the circuitry is to determine the ESN based on concatenation of the ESN value and an SN value.

Example 7 includes one or more examples, wherein the received packet is encrypted in accordance with Internet Protocol Security (IPSec), MACsec, Transport Layer Security (TLS), Datagram Transport Layer Security (DTLS), or Google® PSP Security Protocol (PSP).

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 9 includes one or more examples, and includes a non-transitory computer-readable medium comprising instructions stored thereon, that if executed by one or more processors, cause the one or more processors to: configure a network interface device to: process a received packet, for a first configuration, determine an Extended Sequence Number (ESN) value based on content of the received packet without performance of ESN prediction, and for a second configuration, determine ESN using prediction.

Example 10 includes one or more examples, wherein an Initialization Vector (IV) of a payload of the received packet comprises the ESN.

Example 11 includes one or more examples, wherein the IV is consistent with one or more of Internet Engineering Task Force (IETF) Request For Comment (RFC) 4106, RFC 4543, or RFC 7634.

Example 12 includes one or more examples, wherein the prediction is consistent with Internet Engineering Task Force (IETF) Request For Comment (RFC) 4303, “IP Encapsulating Security Payload (ESP)” (December 2005).

Example 13 includes one or more examples, wherein the received packet is encrypted in accordance with Internet Protocol Security (IPSec), MACsec, Transport Layer Security (TLS), Datagram Transport Layer Security (DTLS), or Google® PSP Security Protocol (PSP).

Example 14 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 15 includes one or more examples, and includes a computer-implemented method that includes: at a network interface device: for a first configuration, including an Extended Sequence Number (ESN) value in a packet prior to transmission, for a second configuration, including a Sequence Number (SN) value in the packet prior to transmission, and transmitting the packet to a receiver network interface device.

Example 16 includes one or more examples, wherein an Initialization Vector (IV) of a payload of the packet comprises the ESN.

Example 17 includes one or more examples, wherein the IV is consistent with one or more of Internet Engineering Task Force (IETF) Request For Comment (RFC) 4106, RFC 4543, or RFC 7634.

Example 18 includes one or more examples, and includes encrypting the packet is encrypted in accordance with Internet Protocol Security (IPSec), MACsec, Transport Layer Security (TLS), Datagram Transport Layer Security (DTLS), or Google® PSP Security Protocol (PSP).

Example 19 includes one or more examples, wherein a header of the packet comprises the ESN.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

1. An apparatus comprising:
a network interface device comprising:
direct memory access (DMA) circuitry,
a network interface,
a host interface, and
circuitry to:
process a packet received by the network interface,
for a first configuration, determine an Extended Sequence Number (ESN) value based on content of the packet without performance of ESN prediction, and
for a second configuration, determine ESN using prediction.

2. The apparatus of claim 1, wherein an Initialization Vector (IV) of a payload of the received packet comprises the ESN.

3. The apparatus of claim 2, wherein the IV is consistent with one or more of Internet Engineering Task Force (IETF) Request For Comment (RFC) 4106, RFC 4543, or RFC 7634.

4. The apparatus of claim 1, wherein a header of the received packet comprises the ESN.

5. The apparatus of claim 1, wherein the prediction is consistent with Internet Engineering Task Force (IETF) Request For Comment (RFC) 4303, “IP Encapsulating Security Payload (ESP),” (December 2005)

6. The apparatus of claim 5, wherein when the packet to be received is encrypted using Internet Protocol Security (IPSec), the circuitry is to not predict the ESN based on an IPSec standard.

7. The apparatus of claim 1, wherein the received packet is encrypted in accordance with Internet Protocol Security (IPSec), MACsec, Transport Layer Security (TLS), Datagram Transport Layer Security (DTLS), or Google® PSP Security Protocol (PSP).

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

9. A non-transitory computer-readable medium comprising instructions stored thereon, that if executed by one or more processors, cause the one or more processors to:
configure a network interface device to:
process a received packet,
for a first configuration, determine an Extended Sequence Number (ESN) value based on content of the received packet without performance of ESN prediction, and
for a second configuration, determine ESN using prediction.

10. The computer-readable medium of claim 9, wherein an Initialization Vector (IV) of a payload of the received packet comprises the ESN.

11. The computer-readable medium of claim 10, wherein the IV is consistent with one or more of Internet Engineering Task Force (IETF) Request For Comment (RFC) 4106, RFC 4543, or RFC 7634.

12. The computer-readable medium of claim 9, wherein a header of the received packet comprises the ESN.

13. The computer-readable medium of claim 8, wherein the received packet is encrypted in accordance with Internet Protocol Security (IPSec), MACsec, Transport Layer Security (TLS), Datagram Transport Layer Security (DTLS), or Google® PSP Security Protocol (PSP).

14. The computer-readable medium of claim 8, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

15. A computer-implemented method comprising:
at a network interface device:
for a first configuration, including an Extended Sequence Number (ESN) value in a packet prior to transmission,
for a second configuration, including a Sequence Number (SN) value in the packet prior to transmission, and
transmitting the packet to a receiver network interface device.

16. The method of claim 15, wherein an Initialization Vector (IV) of a payload of the packet comprises the ESN.

17. The method of claim 16, wherein the IV is consistent with one or more of Internet Engineering Task Force (IETF) Request For Comment (RFC) 4106, RFC 4543, or RFC 7634.

18. The method of claim 15, comprising:
encrypting the packet is encrypted in accordance with Internet Protocol Security (IPSec), MACsec, Transport Layer Security (TLS), Datagram Transport Layer Security (DTLS), or Google® PSP Security Protocol (PSP).

19. The method of claim 15, wherein a header of the packet comprises the ESN.

20. The method of claim 15, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).
